(19) United States
(12) Patent Application Publication
(10) Pub. No.: US 2008/0195970 A1
(43) Pub. Date: Aug. 14, 2008

(54) Smart genre display

(76) Inventors: Paul Rechsteiner, Toronto (CA); Lawrence Kesteloot, San Francisco, CA (US)

Correspondence Address: KALEIDESCAPE, INC., 440 POTRERO AVE., SUNNYVALE, CA, 94085-4117, US

(21) Appl. No.: 11/704,702

(22) Filed: Feb. 9, 2007

(51) Int. Cl. G06F 3/048

(52) U.S. Cl. 715/810

(57) ABSTRACT

Methods including steps of displaying at least one set of array elements in a screen area, with the array elements representing or associated with a set of particular media elements; cycling the array elements; and allowing a user to select an array element. Preferably, the cycling is continuous, and the array elements are cover art for CDs or DVDs. Also, devices and physical media storing instructions that implement these methods.

### BACKGROUND OF THE INVENTION

Current art methods of graphical representation use display images that correspond to media selected by a user. However, current methods do not represent a large local collection in a small screen area with images from a user's library or external metadata, and often require a virtual screen larger than the display screen. Current methods often require a user to scroll or control the movement of the array elements in some way. There are also problems associated with song selection associated with graphical representation.

One problem with selecting songs is that listeners sometimes have extensive libraries of songs they might wish to hear from time to time, but do have a detailed recollection of those songs. For a first example, a listener might have a large number of classical songs, but might not recall just which ones of those songs are the listener's particular favorites. For a second example, a listener might have developed a recent interest in songs by Kelly Clarkson, but not realize that the listener already has songs by that performer in the listener's library, possibly as part of an omnibus package of songs supplied with the listener's music player.

Another problem with selecting songs is that distinct listeners might have differing ways in which they divide up the set of possible playable songs. For a first example, some listeners might have a well-defined set of songs they prefer, such as classical music, while other listeners might have a fuzzier set of songs they are interested in, such as songs “like those” by Billy Joel. For a second example, some listeners might have interest in only some particular subcategories of a well-known set of songs, such as having interest in classical music, while having little interest in one of its particular subcategories, such as chamber music. For a third example, some listeners might have interest in classical music, while distinguishing between various types of classical music, such as etudes, operas, and symphonies.

### SUMMARY OF THE INVENTION

Aspects of the invention attempt to address the above problems.

One aspect of the invention includes techniques, embodied for example in apparatus and methods, for presentation of metadata about media elements, for example as part of a user interface by which listeners might select some of those media elements for presentation.

Another aspect of the invention includes techniques, embodied for example in apparatus and methods, for presentation of metadata about media elements in association with presentation of those media elements themselves.

In one embodiment of the invention, a presentation device, such as a screen viewable by a listener, presents images associated with media elements, such as DVD covers associated with individual songs to be played, using serial collage. Serial collage is a method for representing a large set completely in a small screen area.

Serial collage uses a spatial display that changes over time. On a flat screen, the representation may be two dimensional or might use visual effects to emulate a three-dimensional representation (e.g., perspective, stacking). Alternatively, an actual three dimensional display such as a stereo-optical device (e.g., glasses that project two different images to a user's eyes to generate a three dimensional view) or 3D active hologram can be used. In any case, the representation of set elements cycles over time so that more elements can be represented in the same area. Thus, serial collage does not depend on scrolling, since the collage is already in motion.

Serial collage may be passive, like a slideshow, or selectable by a user. For example, serial collage can be used to represent collections of albums by their cover art. On a descriptive page for a genre or an artist, cover art is displayed in a small square or rectangular array, i.e. 2×2, 3×2, or 3×3, and the array elements or cover art images cycle dynamically through the cover art of the set of albums. The images preferably change slowly with fading, for example in a clockwise or counter-clockwise pattern. Enough time preferably is given so that each element in a set will appear in the array eventually, and each appearance preferably lasts as long as possible.

In a preferred embodiment, plural serial collages that represent plural different genres or groupings of media elements can be presented at once. The user preferably can select a set being represented in a collage. The listener might select one or more of the serial collage images, with the effect of instructing the presentation device regarding the media elements associated with those images. As those skilled in the art would see, the number of ways the listener might instruct the presentation device is broad and varied.

Similarly, a presentation device, such as a screen viewable by a listener, can select a set of one or more media elements, and images associated with those media elements, in response to taxonomy of media elements available to the listener. This genre taxonomy preferably is responsive to some or all of the following: (1) a natural genre taxonomy in common use among a broad group of listeners, (2) a set of information about the listener, such as demographic information, listener preferences, and the like, (3) a set of information about the listener's library, such as a number of media elements in particular groups or subgroups of a natural genre taxonomy, (4) a set of information about the listener's history, such as frequency or recency of particular media elements having been played, frequency or recency of media elements in a genre taxonomy having been purchased, or rejected for purchase, and the like. Again, each genre or grouping preferably can be represented by its own serial collage, and one or more of these collages can be displayed at once.

In some embodiments, a genre taxonomy particular to the listener includes (1) coarser genres when the listener does not prefer media elements of that type, when the listener has fewer media elements of that type represented in the listener's library, and the like, (2) finer genres when the listener does prefer media elements of that type, when the listener has more media elements of that type represented in the listener's library, and the like, and (3) finer genres when the listener distinguishes between media elements of distinct types in the listener's library, and the like.

For one example, a listener who has no particular preference between distinct types of classical music would have all classical music grouped under a single category. For a second example, a listener who has specific preferences for distinct types of classical music would have those distinct types represented as subgroups under the category for classical music. This would have the effect that a listener who likes most classical music, but not chamber music, would have classical music represented as subgroups, with chamber music as a subgroup designated as not preferred by the listener. Similarly, this would have the effect that a listener who has a particular preference for media elements from West Mali, would have that form of music represented as a subgroup of world music, with distinct preference parameters associated with that subgroup, in contrast with the “world music” group.

In the context of the invention, there is no particular requirement that media elements (such as “songs”) are restricted to only audio components, that media elements are restricted to only linear sequences of presentable material, that “listeners” are restricted to only individual human beings or even to human beings at all, and the like. After reading this application, those skilled in the art would recognize that the scope and spirit of the invention includes wide variation in the many possibilities of embodiments of the invention.

These techniques can be performed using a computing device, preferably having access to information about a set of possible songs or other items, information about one or more taxonomies applicable to that set of possible songs or other items, information about a set of listener preferences, information about a set of metadata about songs, about the listener, and information about other aspects of the embodiment in use by the listener (e.g., a number of possible songs available for presentation, a physical position of the embodiment, a set of types of presentation elements available to the embodiment, and the like). In one or more embodiments, at least some of that information is available to the embodiment from an external database.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows a block diagram of a user interface related to presentation of metadata about media elements;

FIG. 2 shows a set of visual array elements or serial collage related to the user interface described herein;

FIG. 3 shows a block diagram of a system related to the user interface described herein; and

FIG. 4 shows a process flow diagram of a set of methods related to the user interface described herein.

### DETAILED DESCRIPTION

### Generality of the Description

This application should be read in the most general possible form. This includes, without limitation, the following:
References to specific structures or techniques include alternative and more general structures or techniques, especially when discussing aspects of the invention, or how the invention might be made or used.
References to “preferred” structures or techniques generally mean that the inventor(s) contemplate using those structures or techniques, and think they are best for the intended application. This does not exclude other structures or techniques for the invention, and does not mean that the preferred structures or techniques would necessarily be preferred in all circumstances.
References to first contemplated causes and effects for some implementations do not preclude other causes or effects that might occur in other implementations, even if completely contrary, where circumstances would indicate that the first contemplated causes and effects would not be as determinative of the structures or techniques to be selected for actual use.
References to first reasons for using particular structures or techniques do not preclude other reasons or other structures or techniques, even if completely contrary, where circumstances would indicate that the first reasons and structures or techniques are not as compelling. In general, the invention includes those other reasons or other structures or techniques, especially where circumstances indicate they would achieve the same effect or purpose as the first reasons or structures or techniques.

After reading this application, those skilled in the art would see the generality of this description.

### Definitions

The general meaning of each of these following terms is intended to be illustrative and not in any way limiting.
The term “media element” and the like generally describes any and all data capable of being interpreted as information presentable by an embodiment to a listener, by any sensory technique, or in the case of a nonhuman listener (as described above) by any technique for sending information. A media element might include audio components, (e.g., songs, music, lyrics, dialogs or monologues, speeches, sound tracks from audiovisual works, sound effects, and the like), pictoral components (e.g., still photographs, motion pictures, movies, video clips, animation, Macromedia “Flash” presentations, lighting changes or other lighting effects, and the like), digital information (e.g., database records or database query resuits, computer program objects, video game rules and controls, screen saver parameters, other parameters for controlling computing devices, and the like), combinations and mixtures thereof, and the like. For one example, the term “media element” is broad enough to include a “surround sound” component, a haptic component, an aromatic component (e.g., such as in a flight simulator, 3D “virtual reality” game or simulation, aromatherapy, and the like), or another type of component.
The term “title” and the like generally describes a name assigned to a media element, for example but not limited to name assigned by an author, performer, publisher, owner, or user of the media element.
The term “image” and the like generally describes a visual representation of a real or imagined person, a real or imagined object, or a real or imagined scene, such as a painting, drawing, photograph, digital photograph, motion picture, and the like. An image can be in color or black and white, still or in motion, in digital or analog form, and stored in a computer or printed, developed, or otherwise generated in “real world” form. The term “image” also encompasses a file that stores such a visual representation.
The term “array” and the like generally describes a square, rectangular, or other shaped pattern. An array might include any type of tiling, such as for example any regular planar tilings or any arbitrary patched coverings. An array might also appear to fill a particular geometric area or volume, such as a square, a rectangle, a parallelepiped, a surface of a sphere, or a surface of a torus. These areas or volumes do not have to be regular geometric shapes. Moreover, as shown below, with the proper use of perspective, these areas or volumes can appear to be infinite.
The term “fade” and the like generally describes a process of appearing or disappearing over time.
The term “fade pattern” and the like generally describes a pattern by elements in an array of elements fade in or out.
The term “random” and the like generally describes an arrangement, process, or other thing that does not have a predictable, known, or fixed pattern. Rather, each part of the arrangement, process, or thing has a mathematically equal chance of occurring in its particular position, order, location, or the like.
The term “pseudo-random” and the like generally describes something that appears to be random, but may or may not actually be random. For example, an arrangement generated using a computer's “random” function typically is not actually random in a strict mathematical sense, but rather is pseudo-random and only appears to be random upon casual observation.
The term “perceptually random” and the like generally describes something that is not random, but may be perceived to be random or even more random than truly or pseudo-random by listener, for example by avoiding repetitions, measuring coincidence or similarities between songs and successively playing songs responsive to these measures, and the like.
The term “genre” and the like generally describes a class or category of artistic endeavor having a particular form, content, technique, or the like.
The term “taxonomy” and the like generally describes a system, method, or arrangement of classification or categorizing.
The term “granularity” and the like generally describes a level of detail or specificity of a class or category.
The term “set formation” and the like generally describes grouping of media elements into sets or groups, for example but not limited to by genre, taxonomy, user preference, system settings, random selection, pseudo-random selection, perceptually random selection, and the like, preferably responsive to metadata associated with the media elements.
The term “local” and the like generally refers to being close or near to each other, either physically or logically.
The term “remote” and the like generally refers to being far from each other, either physically or logically.
The term “library” and the like generally refers to a collection of items such as media elements.
The term “ownership” and the like generally refers to a right of possession, control, and/or use.
The term “speculative download” and the like generally refers to a download that occurs before selection or confirmation that a user desires the download.
The term “usage history” and the like generally refers to a record of past use of items such as media elements.
The term “purchase history” and the like generally refers to a record of past purchases of items such as media element.
The term “non-purchase history” and the like generally refers to a record of items such as media elements that were viewed, chosen, and/or selected, but not actually purchased.
The term “computing device” and the like generally refers to any device that can execute instructions, for example but not limited to a desktop computer, a laptop computer, a PDA, a sub-notebook, a CD or DVD player, an ear-bud audio device, an ipod or equivalent device, and the like.
The term “communication link” and the like generally describes a connection over which communication occurs. A communication link can be between any two or more entities and/or things such as people, computing devices, other devices, and the like. A communication link can be over wire, wireless, fiber optics, light, sound, or any other medium.
The term “listener” and the like generally describes any and all recipients of information to be presented in the form of a set of array elements, including without limitation one or more persons, one or more organizations or other legal entities, one or more non-human animals, one or more computing devices or other circuits disposed to act upon, manipulate, store or transmit, or otherwise respond to, that information.
The phrase “listener preferences” and the like generally describes any and all aspects by which a preference exists for presenting array elements or cover art, as broadly defined, to one or more listeners. A listener preference might be broad or specific, explicit or implicit, fuzzy or precise, proposed by the listener or by a teacher (or other external agent), responsive to information from the listener or from an external database, strictly ordered or partially ordered, and the like. For one example, a set of listener preferences might be time-varying with a mood of the listener, with the latter involving real-time detection.
The term “metadata” and the like generally describes any and all information or data maintained, stored, received or transmitted, and the like, about a media element, but not actually included in the data representative of a media element, device, or other object. For a first example, metadata about a media element might include its title, author, performing artist, publisher, genre, year released, composer, instrumentation, length, bit rate of encoding, and the like. For a second example, metadata about a listener might include that listener's name, gender, age, profession, income, VALS classification, and the like. For a third example, metadata about a particular system which is an instance of an embodiment might include information about that particular system, e.g., one or more national languages in use, a physical location for that system (whether or not portable), a measure of whether that system is relatively “high end” or relatively “low end”, such as a disk capacity or number of presentation zones for that system, and the like. For a fourth example, metadata about a library for that system might include media elements stored on the system, media elements most recently accessed by the system, media elements most frequently accessed by the system (whether recently or for a longer time), a frequency and volume of purchases of new media elements by listeners for that system, a set of external databases most frequently accessed by the system (whether recently or for a longer time), and the like. For a fifth example, metadata associated with a media element might include the artist, associated other titles, cover art, genre, physical box of originating media, physical side of originating media, publisher, media element length, title, track location or track number, year of release, and the like, as well as any other information convenient or useful for identifying media elements besides actually listening to them. A system can manage licensed metadata and knows where to find different kinds of metadata from different sources. The system may cache significant portions of metadata.

The scope and spirit of the invention is not limited to any of these definitions, or to specific examples mentioned therein, but is intended to include the most general concepts embodied by these and other terms.

### User Interface

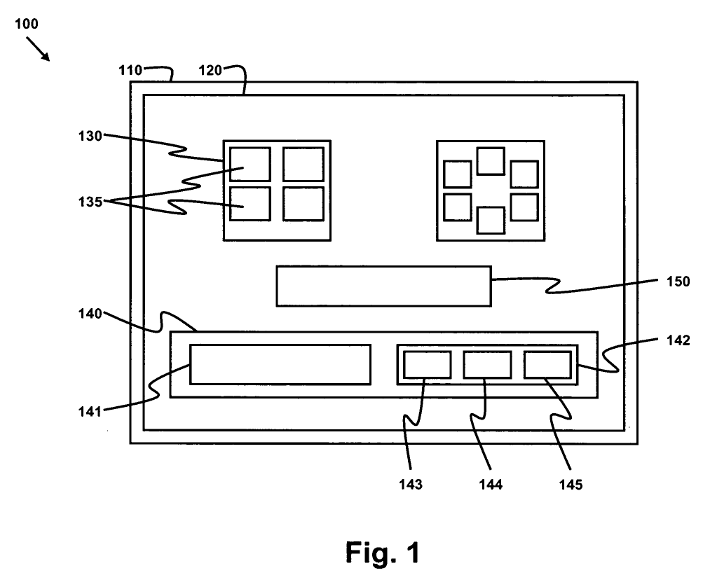

FIG. 1 shows a block diagram of a user interface related to presentation of serial collages, play information, and metadata about media elements.

User interface 100 includes elements shown in the figure, including at least a screen 110 with an active portion 120. In a preferred embodiment, the active portion 120 includes as much of the screen 110 as can be allocated to the user interface 100. The active portion includes at least one serial collage 130 that each includes a set of visual array elements 135. Serial collages are discussed in more detail below under “Serial Collage.”

The active portion also preferably includes a set of controls 140. These controls can include controls 141 that can be used in many different ways to control presentation of media elements, display of images such as cover art associated with the media elements, and the like. The following examples are merely exemplary of the many possibilities available to the listener:
The listener might direct the presentation device to display cover art for CDs, DVDs, and the like.
The listener might direct the presentation device to display cover art in a small square or rectangular array, such as a 2×2 small square array, a 2×3 small rectangular array, a 3×3 small square array, and the like.
The listener might direct the presentation device to fade the cycling slowly in a clockwise or counter-clockwise pattern.
The listener might specify a database filter rule to select a set of array elements, which could consist of items from a user's library, or include external information in response to external metadata.
The listener might direct the presentation device to weight the set of array elements according to relative importance of the elements.
The listener might direct the presentation device to display elements of different frequency, size, durations, in different focus, of different resolution, in different opacity, or different distances from center.
The listener might direct the presentation device to display elements responsive to similarity, type or rank, or where set form ation for the media elements, and therefore the images for each serial collage, is responsive to system settings, or user preferences.
The listener might direct the presentation device to display a collage structure in response to system settings, or user preferences.
The listener might direct the presentation device to incorporate sound responsive to metadata.
The listener might direct the presentation device to allow a user to purchase elements missing from the user's library.
The listener might direct the presentation device to present more information about media elements associated with one or more selected visual array elements, such as in those cases where the listener recognizes the one or more visual array elements, but does not completely recall the associated media elements.
The listener might direct the presentation device to play one or more selected media elements, either by queuing those media elements for later play, or by playing those media elements immediately, possibly even interrupting the media elements currently being played to do so.
The listener might direct the presentation device to download or to purchase one or more selected media elements. In the context of the invention, there need not be any connection between whether or not the selected media elements are physically located at the presentation device, or whether the listener has specific rights to play those media elements. For some examples, the listener might have rights to play media elements that are not currently downloaded onto the presentation device, or might have media elements currently downloaded onto the presentation device without yet having rights to play those media elements.
The listener might inform the presentation device about some of the listener's preferences regarding one or more selected media elements, either positive (the listener likes that media element) or negative (the listener does not like that media element). In the context of the invention, there need not be any connection between the listener's expression(s) of preferences, and whether the media element has been played, is being played, or is scheduled to be played.
The listener might direct the presentation device to perform a search, such as (1) one related to one or more of the displayed images, (2) one related to media elements “nearby” one or more of the displayed images, (3) one related to the genre taxonomy, (4) and the like.
The listener might direct the presentation device to alter its display of images, such as for the presentation device to select a new set of media elements and associated images for display.
The listener might direct the presentation device to (1) display the genre taxonomy, or (2) add to or otherwise modify the genre taxonomy, and the like.

Although the term “listener” is used in the foregoing discussion, the concepts are equally applicable to viewers and other users of media elements of different types.

Controls 140 can also include controls 142 that might be manipulated by the user to effect functions of generic value in playing media elements. In a preferred embodiment, these might include one or more of the following:
A main menu 143 or other interface to the system 100, including a set of controls that might be manipulated by the user to effect functions provided by the system 100, such as turning off the whole system.
A set of sound controls 144 or other interface to a sound sequence output (not shown), including a set of controls that might be manipulated by the user to effect functions such as control of volume, balance, speaker selection, individual presentation device control, parental restrictions on individual presentation devices, and the like.
A set of media element play controls 145 that might be manipulated by the user to effect functions commonly available with CD and DVD players. Examples include functions to play, restart, rewind, back up, pause, continue, skip forward, fast forward, and stop playing.

Those skilled in the art will recognize that the foregoing examples of controls 140 are merely exemplary. The listener might have a large number of alternative possibilities for (1) commands to the presentation device, (2) listening to media elements, (3) viewing images associated with media elements, and the like.

User interface 100 also preferably includes a set of media element play information 150 related to one or more media elements being played or selected to be played. This information can include some, all, or none of the following: dynamic sound frequency, duration, volume, bitrate of data encoding, any other information relating to performance aspects of the media element, information responsive to metadata for a media element that is being played, and the like. Play information 150 also can include information relating to how much time a media element will take to play, how long the media element has been playing and what percentage of it has been played, and how long the media element has left to play and what percentage of it has yet to be played.

In a preferred embodiment, this information is updated frequently, with the visual effect that a progress bar changes color over time from the beginning to the end of the media element.

### Metadata

In a preferred embodiment, metadata associated with each media element might include the artist, associated other titles, cover art, genre, physical box of originating media, physical side of originating media, publisher, media element length, title, track location or track number, year of release, and the like. There can be several different kinds of images representing metadata. For example, a media element might be associated with an image of the media element's composers or performers, an image of the album on which the media element appeared, an image of a corporate logo of the company that released or distributed the media element. A metadata library preferably is a relational database, so some items can have many related images and some images can be related to many items. Sometimes, an image serves as a distinct identifier, for example when a company has one logo associated with it.

### Serial Collage

Each serial collage 130 includes a set of visual array elements. The elements preferably include images 135 that represent or are associated with particular media elements, for example but not limited to CD or DVD cover art. Images 135 preferably are displayed in a small square array (e.g. 2×2 or 3×3), a small rectangular array (e.g. 2×3 or 3×2), another shaped array, or the like.

The array preferably cycles through plural of the images, thereby permitting more images than array elements to be displayed. In a preferred embodiment, the images change slowly with fading in a clockwise or counter-clockwise fade pattern in the serial collage. Cycling of the images in the serial collage is explained in more detail below.

Text, images, or both responsive to metadata and/or other data associated with media elements represented by images in a serial collage also can be displayed along with the serial collage. The text or images preferably are obtained from an optional metadata database, as discussed below.

Serial collage addresses the problem of displaying a complete set of images representing a set of media elements in a small screen area. Serial collage uses a spatial display that changes over time. On a flat screen, the representation may be two dimensional or might use visual effects to emulate a three-dimensional representation (e.g., perspective, stacking). Alternatively, an actual three dimensional display such as a stereo-optical device (e.g., glasses that project two different images to a user's eyes to generate a three dimensional view) or 3D active hologram can be used. In any case, the representation of set elements cycles over time so that more elements can be represented in the same area. Thus, serial collage does not depend on scrolling, since the collage is already in motion.

For example, serial collage can be used to represent collections of albums by their cover art. On a descriptive page or portion of displayed screen for a genre or an artist, cover art can be displayed in a small array, i.e. 2×2, 3×2, or 3×3 grid or some other pattern, and the visual array elements or cover art images cycle dynamically through the cover art of the set of albums. The images preferably change slowly with fading, for example in a clockwise or counter-clockwise pattern. Enough time preferably is given so that each element in a set will appear in the array eventually, and each appearance preferably lasts as long as possible.

In one embodiment of a 2×2 array, the first four serial collage cycles occur quickly in succession, followed by a pause with no changing, then the next four elements cycle quickly, and so on. In this example, the replacement pattern appears to occur in waves.

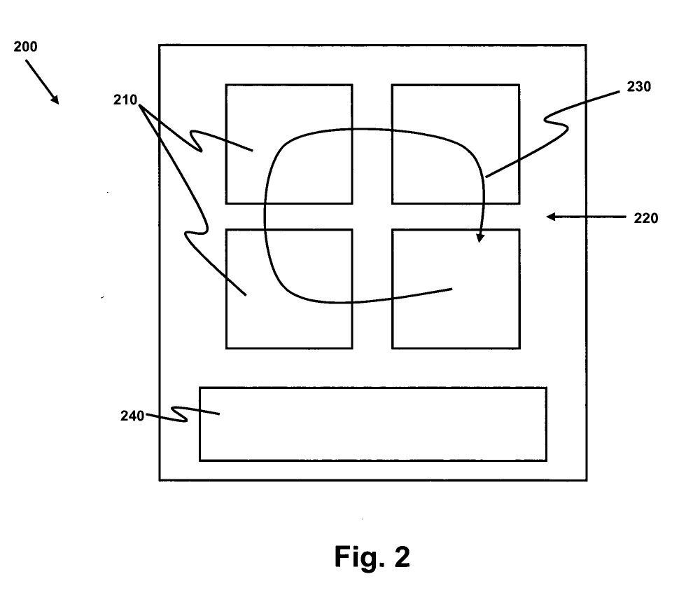

FIG. 2 shows a block diagram of a serial collage in more detail.

### Visual Array Elements

A serial collage 200 includes elements shown in the figure, including at least the following: visual array elements 210, array 220 of those elements, replacement pattern 230, and text and/or other images 240.

A serial collage 200 includes a graphical representation of a set of media elements. One or more serial collages can be displayed at once. A serial collage preferably includes a set of visual array elements 210 that represent or are associated with media elements in the set. The serial collage can also include text or images 220 responsive to metadata associated with the media elements.

The visual array elements 210 preferably are images, either static or active (e.g., a short loop of images or an animation). The images can be from local metadata associated with the media elements or can be from another source, for example but not limited to an internal database or external server or database. For example, visual array elements could be drawn from licensed icons and images or covered art. Furthermore, the visual array elements are not necessarily derived from the source data.

Each visual array element preferably represents one media element, although an element can represent plural media elements, for example but not limited to one or more media elements from an album, CD, or DVD, and plural images can represent one media element or different version of one media element.

Representation of the visual array elements 210 may be weighted according to their relative importance as members of a set. The representation of those elements may be responsive to this weighting by displaying elements with different frequency, size, duration, focus, resolution, opacity, distance from center, and the like. The representation may be responsive to similarity. Set elements may have groupwise or pairwise similarity relationships according to their metadata, and the representation may be responsive to this similarity by grouping elements near each other in time and space.

The representation can be responsive to type or rank. A set 240 to be represented may have elements of different types and their representations may be responsive to these types. Media elements, albums, and mix albums may have different cover art.

The visual array elements 210 for each serial collage preferably are arranged in array 220 when displayed. In a preferred embodiment, the array is a small square grid, e.g., 2×2 or 3×3 grid or a small rectangular grid, e.g., 2×3 or 3×2 grid. Alternatively, the array can have a different pattern or shape. The array can include fewer positions for visual array elements 210 than the number of media elements in the set of elements represented by the serial collage. Replacement pattern 230 (represented by an arrow in FIG. 2) preferably is used to cycle through the visual array elements shown in the array.

In one embodiment, replacement pattern 230 involves changing the visual display elements slowly with fading in a clockwise or counter-clockwise pattern. Over time, each element 210 in the set will appear in the array eventually, and each appearance lasts as long as possible. In one embodiment in which the array includes a 2×2 format, a first four (2 times 2) replacement patterns 230 or cycles occur quickly in succession, there is a pause with no changing, then a next four elements cycle quickly, and so on, having the effect that the replacement pattern 230 appears to occur in waves. Other replacement patterns can be used.

Serial collage also can include text and/or other images 240 related to the media elements represented in the serial collage. This text and/or other images can include any information from metadata associated with the media elements, a description of the set of media elements represented by the collage, a description of a rule used to select the media elements for the collage, and the like. The text and/or other images can be responsive to local data including but not limited to a local metadata database, a local library of media elements, system settings, user selections, and the like. The text and/or other images also can be responsive to remote data, for example but not limited to a remote metadata database, a remote library of media elements, a remote web server, and the like.

Serial collage 200 is primarily a visual technique, but the collage 200 may include sound and other effects. However, it is understood that visual collages can be appealing and informative about media elements in a set represented by the collage, while sound collages can be unpleasantly cacophonous and confusing because listeners may not be able to recognize short sound clips even when played in sequence. Serial collage 200 may play sounds corresponding to displayed elements. Sound performance may be synchronized to the display of visual array elements 210 in serial collage 200, or the performance may be deliberately asynchronous. Sounds may be responsive to metadata associated with the media elements.

In a preferred embodiment, plural serial collages that represent plural different sets, genres or groupings of media elements can be presented at once, either on separate pages, windows, or screens, or on one page, window, or screen. Alternatively, only a single selected or specified serial collage might be displayed.

Serial collage may be passive, like a slideshow, or selectable by a user. Preferably, a user can select a set being represented in a collage. The listener might select one or more of the serial collage images, with the effect of instructing the presentation device regarding the media elements associated with those images. As the number of ways the listener might instruct the presentation device is broad and varied. Some of these are discussed above in the context of controls 140.

Furthermore, visual array elements within a serial collage might be selectable. A user may select collage elements as input to call other system features. In a preferred embodiment, one-click features or zero button philosophy is preferred over multiple options of an expert system. Selection may not change the representation of the collage 200. Selecting an item may do some other system action, such as performing a media element associated with a selected visual array element. Alternatively, selection may serve as a navigational method within a collage 200. For example, selecting one artist in the collage 200 can replace the display with a new collage of elements associated to that artist. Selection of a visual array element might perform some other function, for example but not limited to directing a browser to a web site for purchasing similar media elements or media elements by other authors, directing a browser to a web site identified in metadata for the media element, and other functions and operations.

### Set Formation

As discussed above, each serial collage corresponds to a set of media elements. The process of forming such a set is referred to as “set formation” herein.

Set formation can be responsive to user selection, displaying detailed information about the set the user has selected. Set formation also can be in response to a user's library, wherein the represented set consists of items in a user's library. Forming sets in the local library can require that some metadata associated with media elements be characterized for filtered. For example, a user might select a set in their library by specifying a database filter rule.

Set formation also can be responsive to external data or metadata. For example, users could create and post data representing sets to a message board or file, allowing users to share sets.

Set formation can be responsive to system settings and user preferences. For example, selecting “all artists” may form a set of popular artists, where popularity is determined by a system or user cut-off rule. The collage structure may be responsive to system settings and user preferences. The system or the user may decide that a 2×2, 3×3, or other shaped collage 200 is best for a particular set.

In some embodiments, set formation can have commercial aspects. For example, a set can be expanded to include similar elements that are not in the user's library. Similarity can be determined by comparison to set elements or by applying the set formation rule to a larger external library. The representation of these items would be responsive to their status, e.g. visual array elements for media elements that are not available to a user by can be purchased might appear relatively gray, faded or transparent compared to availably set elements. In this case, there preferably would be some simple method for buying these new items. For example, selecting the gray, faded, or transparent visual array elements might open a window to an online retailer of the associated media element.

### 2D and Other Nonlinear Formats

In a preferred embodiment, frames displaying visual array or media elements might be disposed in a 2D format, such as for example a 2×2, 3×3, 2×3, or 3×2 array of media elements. Serial collage 200 is not restricted to squares or rectangles for displaying the visual array elements. For example, non-rectilinear arrangements such as a 2-3-2 hexagonal arrangement can be used. In addition, three dimensional (either actual or emulated) can be used.

Serial collage 200 may give more importance to some elements by giving them more area or more time in the array. The total area used by the collage 200 may expand and contract. There may be many replacement patterns 230 for serial collages 200, not just the clockwise wave pattern discussed herein. The replacement pattern 230 may be easily recognizable, such as clockwise or top to bottom shift, with the intention that the user can follow and anticipate the replacement pattern 230 even if they cannot predict which elements in a large set will turn up in collage 200. The replacement pattern 230 may be random, pseudo-random, perceptually random, or non-random. While fading was discussed herein, it is understood that the replacement pattern 230 may include having visual array elements slide, stack, pop, rotate, and the like. The collage 200 may have a nested structure wherein the representation of a particular collage element may comprise a finer collage within itself.

It might occur that not all media element icons would fit into a displayed array. In such cases, the system might select, in addition or in lieu of distinguishing the array element, to rearrange the media element icons to place the media element icon in a particular position within a formatted array (such as, the upper left corner). The system might also select, in addition or in lieu of distinguishing the array element, to re-select a new visual array element to represent the media elements being played.

After reading this application, those skilled in the art will recognize that the possibilities for other and further techniques for application to display of visual array elements in a serial collage to represent a set of media elements.

### System Elements

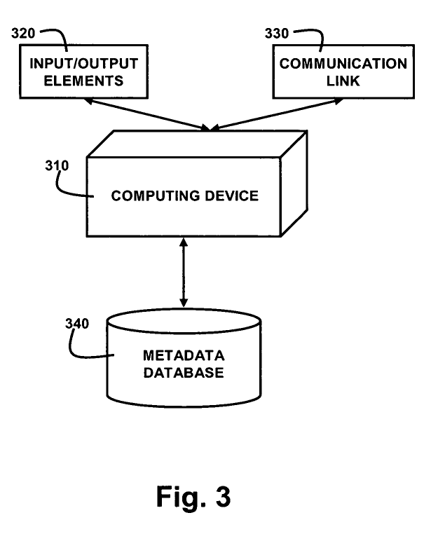

FIG. 3 shows a block diagram of a system related to the user interface described herein.

### Computing Device

A system includes elements shown in the figure, including at least the following: computing device 310, input/output elements 320, (optional) communication link 330, and (optional) metadata database 340.

In a preferred embodiment, a major physical portion of the system would be located in, or coupled to, a computer or laptop computer. This would include at least the computing device 310, the input/output elements 320, and preferably at least part of the communication link 330.

The computing device 310 includes elements not shown in the figure. A computing element includes a processor, memory, and mass storage, configured as in a known desktop, laptop, or server device. In a preferred embodiment, the mass storage might include both attached mass storage, such as a hard disk drive, and removable mass storage, such as a CD or DVD reader or writer. However, in the context of the invention, there is no particular requirement that the computing element include those elements, so long as the computing element is capable of performing the maintaining its state as described herein, and performing the method steps described herein. For a first example, there is no particular requirement that the computing element include any particular form of mass storage, although the inventors expect that a preferred embodiment will include both forms of mass storage described above. For a second example, there is no particular requirement that the computing element is structured as a deterministic device-nondeterministic devices, such as including parallel processing devices, would work as well.

In the context of the invention, there is no particular requirement that the computing element be configured as in a known desktop, laptop, or server device. For several alternative examples, the computing element might be configured as in a cellular telephone, a hand-held audio or video player, a hand-held computing device, a headsup display device for spectacles or contact lenses, a one-way or two-way, “Dick Tracy” communication wristwatch, a PDA, a sub-notebook, an ear-bud audio device, an ipod or equivalent device, and the like. After reading this application, those skilled in the art would recognize that the nature of the invention is broad enough to include, within its scope and spirit, virtually any form of input or output hardware or software, having a user interface as described herein.

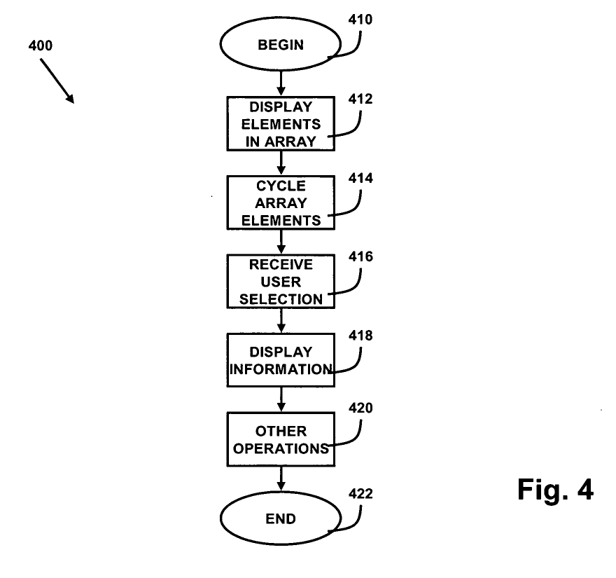

Computing device 310 executes instructions to implement the user interface described above with respect to FIG. 1 including one or more serial collages described above with respect to FIG. 2. The instructions can be stored or retrieved from a local source such as a physical medium or memory (e.g., disk, hard disk, DVD, or some other local storage medium). Alternatively, the instruction can be stored or retrieved from a remote source, possibly over communications link 330. FIG. 4 shows possible steps performed by these instructions.

### Input/Output Devices

The input/output elements 320 include elements not shown in the figure. In a preferred embodiment, a sound sequence input might include a reader for any particular physical media on which sound sequences can be stored, such as CD, DVD, or a set of memory or mass storage (e.g., in the latter case, hard disk drives). In alternative embodiments, the sound sequence input ay in addition or instead include a receiver for any particular communication of sound sequences, such as a radio, television, or computer network input. In the context of the invention, there is no particular requirement for any individual choice of physical devices for the sound sequence input, so long as the computing device 310 is capable of maintaining the information, and performing the methods, as described herein, with respect to those sound sequences. As noted above, in one embodiment, the sound sequence input might be included in a home theater or home entertainment system.

In one embodiment, a home theater or home entertainment system includes a sound sequence output. In the context of the invention, there is no particular requirement for the physical construction of the sound sequence output, so long as the computing device 310 is capable of presenting sound sequences to the user.

The input/output elements 320 include elements not shown in the figure. In a preferred embodiment, a user directives and information input might include a user input of any type coupled to the computing device 310, and is capable of receiving messages from the user on behalf of the computing device 310. For example, the user directives and information input might include a touch panel screen, a keyboard, a pointing device, or a remote control such as used for viewing television or movies.

In a preferred embodiment, the user directives and information output might include a user output of any type coupled to the computing device 310, and is capable of sending messages to the user on behalf of the computing device 310, e.g., as part of a user interface. For example, the user directives and information output might include any hardware devices for presenting visual screen elements, such as a flat panel screen or a touch panel screen. In a preferred embodiment, the output device is capable of presenting the screen elements in the user interface for using media elements (see FIG. 1).

In the context of the invention, there is no particular requirement that either the information input or the information output comprise only a single device. In alternative embodiments, either one or both might include multiple such devices. For one example, the information input might include more than one device, operating in conjunction to provide a combined set of input information. For another example, the information input might again include more than one device, operating instead with distinct degrees of priority, with the effect that one such device might override commands or other input from another. Similarly, the information output might include multiple user interfaces. For one example, the information output might include more than one device, operating in conjunction to provide a combined set of output information; for another example, the information output might include more than one device, operating instead with distinct degrees of priority, with the effect that one user interface might override presentation or other information sent to another.

For some examples, the information input might receive information from the listener by a wide variety of other techniques, including one or more of:
using a gesturing device, such as used with the Nintendo “Wii” device;
using a keyboard;
using a motion detector (including the possibility of detecting pointing by the listener, detecting simulated typing by the listener as if on a keyboard, or detecting generalized gestures by the listener);
using a pointing device;
using a television “remote” controller (regardless of whether the communication between the remote and the system uses electromagnetic signals in the radio, infrared, visible spectra, or otherwise, or whether that communication uses sonic signals in an audio or ultrasonic band, or otherwise, or whether that remote is coupled to the system using another technique);
using a voice recognition or other sound-recognition device.

Similarly, for some examples, the information output might provide information to the listener by a wide variety of other techniques, including one or more of:
a 2D visual display, such as a CRT display, LCD display, television set, monitor, screen projection device, plasma panel device, and the like;
a 3D visual display, whether physically 3D (e.g., a stereo-optical device or 3D active hologram) or a simulated version of 3D (e.g., a 2D presentation including perspective and overlap) device;
a haptic device (i.e., a motion-producing device), such as a device for buzzing or for shaking the listener's chair;
a printing device;
a set of multiple output devices, such as more than one display screen arranged to present an output in a visually appealing way;
a speaker or other sonic output device.

In a preferred embodiment, a single hardware device might include both the user directives and information input and output. For example, a touch panel screen can both receive input from the user and send visual messages to the user.

In the context of the invention, there is no particular requirement that either the information input or the information output are hardware devices or have specific hardware interfaces. For example, the information output might include a server for an HTTP protocol (or one like it, such as SHTTP), and might be accessed using any web browser, FTP client, WSDL application, and the like.

In a preferred embodiment, an external message input might include an input of any type coupled to the computing device 310, and is capable of receiving external messages on behalf of the user. For example, the user command input might include a connection to the Internet.

In a preferred embodiment, the output external messages might include an output of any type coupled to the computing device 310, and is capable of sending external messages on behalf of the user.

For example, the user command output might include a connection to the Internet.

### Communication Link

An (optional) communication link 330 preferably is coupled to the computing device 310, at a first end, and to an external communication network, such as the Internet, at a second end. In a preferred embodiment, the communication link 330 transfers messages between the computing device 310 and any external devices with which the computing device 310 communicates, including the (optional) metadata database 340.

### Metadata Database

In a preferred embodiment, the system includes a metadata database 340. The metadata database includes elements not shown in the figure. In a preferred embodiment, the system would obtain information, including metadata about media elements and media elements, from stored metadata, using a database interface. The database interface might be as simple as a memory register (with the database 340 accordingly being as simple as a reserved location in a memory), or might be a more complex element, such as a client/server query-and-response technique (with the database 340 accordingly possibly being a more complex element, such as an SQL database). The system manages licensed metadata. The system knows where to find different kinds of metadata from different sources and the system may cache significant portions of metadata.

In a preferred embodiment, the system would cache at least some information from the database 340 for rapid reference, particularly if the stored metadata is located at a relative distance or using the technique in which there is a relative cost to re-obtain that information. In some embodiments, the system might maintain a cache of stored metadata for those media and media elements currently being presented, or about to be presented, to a listener.

In a preferred embodiment, the metadata database 340 might include a relatively remote set of stored metadata, such as maintained using mass storage on a logically or physically remote server. However, in the context of the invention, there is no particular requirement that stored metadata is remote. In some alternative embodiments, the system may include a relatively complete set of metadata for all media elements in the listener's library, downloaded or otherwise maintained in storage for those media elements when those media elements are incorporated into that library. In some other alternative embodiments, the system may dynamically generate metadata in response to information available from the media element itself.

### Methods of Operation

FIG. 4 shows a process flow diagram of a set of methods related to the user interface described herein.

A method 400 includes techniques for presenting a visualization of media elements and data structures. This method 400 includes flow points and steps shown in the figure, including at least the following:

A flow point 410 defines a beginning of the method 400.

At a step 412, the method 400 displays media elements in a visual array. In a preferred embodiment, frames displaying media elements might be disposed in a 2D format, such as for example a 2×2 array or a 3×3 array of media elements, or even a non-rectilinear arrangement such as a 2-3-2 hexagonal arrangement. As described below, the frame representing the current structured media element may have a graphic design that clearly distinguishes it among the sequence of frames. In a preferred embodiment using such techniques, the system uses a 2×2 or 3×3 array to display media array elements or cover art dynamically. The cover art represents particular media elements or albums, movies, and the like. A database filter rule can be specified for selecting a set of array elements. The set of array elements can consist of items from a user's library. The set of array elements can include external information in response to external metadata. The set of array elements can be weighted according to relative importance. For example, elements could be displayed depending upon their frequency, size, duration, focus, resolution, opacity, or distance from center. Elements could be displayed responsive to similarity, type or rank. Set formation can be responsive to system setting, or user preferences. Collage structure can be responsive to system settings, or user preferences. In one embodiment, sound can be included responsive to metadata. However, it is understood that incorporating sound in a dynamically cycling collage can be confusing and frustrating to a user, who may have difficulty identifying a media element or album from a small sound byte. In such embodiments, the system causes the cover art to cross-fade, one fading out while the other fades in, rotating in a clockwise pattern.

It might occur that not all media element icons of the current media element would fit into the 2D formatted array. In such cases, the system might select, in addition or in lieu of distinguishing the current media element, to rearrange the media element icons to place the current media element icon in a particular position within the 2D formatted array (such as, the upper left corner). The system might also select, in addition or in lieu of distinguishing the current media element, to re-select a new set of media element icons to represent the current media elements being played.

At a step 414, the method 400 cycles array elements. In a preferred embodiment, elements are cycled by cross-fading in a clockwise pattern. This, and other possible patterns, are sometimes referred to herein as “replacement patterns”. It is understood that elements can be cycled or replaced in other ways than fading, e.g. sliding, stacking, popping, rotating, and the like. A user can make a selection of an array element for playing a selected item, purchasing a selected item, obtain more information about the selected item, or the like.

At a step 416, the method 400 receives a selection from a user for a media array element, as described above. In a preferred embodiment, the user selections include a set of generic user selections, such as those described above with reference to controls 140. A user could be given an option to select and purchase elements not already included in the user's library.

At a step 418, the method 400 preferably displays more information or options regarding the user's selection of a media array element. For example, if a user wants to make a purchase, information regarding the array elements and the user's options would be displayed here.

At a step 420, the user preferably can instruct a device to perform various other operations on or with the array, the media elements, or the like, for example through manipulation of controls such as controls 140.

A flow point 422 defines an end of the method 400.

### GENERALITY OF THE INVENTION

This invention should be read in the most general possible form. This includes, without limitation, the following possibilities included within the scope of, or enabled by, the invention.

After reading this application, those skilled in the art would see the generality of this application.

1. A method, including steps of
displaying at least one set of array elements in a screen area, with the array elements representing or associated with a set of particular media elements;
altering the array elements in the display according to a defined replacement pattern; and
allowing a user to select one or more array elements.

2. A method as in claim 1, wherein the steps of altering are substantially continuous.

3. The method of claim 1, wherein the array elements include cover art for CDs or DVDs.

4. The method of claim 3, wherein the cover art is displayed in an array having fewer elements than the media elements in the set.

5. The method of claim 1, wherein the array is a 2×2 or 3×3 square array.

6. The method of claim 1, wherein the array is a rectangular or non-rectilinear array.

7. The method of claim 1, wherein the replacement pattern comprises fading slowly in a clockwise or counter-clockwise pattern.

8. The method of claim 1, further comprising specifying a database filter rule to select a set of array elements.

9. The method of claim 8, wherein the set of array elements includes substantially only items from a user's library.

10. The method of claim 1, wherein the set of array elements includes external information in response to external metadata.

11. The method of claim 1, wherein presentation the set of array elements is weighted in response to relative importance of the elements.

12. The method of claim 1, further comprising displaying elements of different frequency.

13. The method of claim 1, further comprising displaying elements of different size.

14. The method of claim 1, further comprising displaying elements for different durations.

15. The method of claim 1, further comprising displaying elements in different focus.

16. The method of claim 1, further comprising displaying elements of different resolution.

17. The method of claim 1, further comprising displaying elements of different opacity.

18. The method of claim 1, further comprising displaying elements in different distances from center.

19. The method of claim 1, further comprising displaying elements responsive to similarity.

20. The method of claim 1, further comprising displaying elements responsive to type or rank.

21. The method of claim 1, wherein set formation for the media elements is responsive to system settings.

22. The method of claim 1, wherein set formation for the media elements is responsive to user preferences.

23. The method of claim 1, wherein a collage structure is responsive to system settings.

24. The method of claim 1, wherein a collage structure is responsive to user preferences.

25. The method of claim 1, further comprising presenting sound associated with the media elements responsive to metadata.

26. The method of claim 1, further comprising allowing a user to purchase elements missing from the user's library.

27. A physical medium including information interpretable by a computing device, the information including
at least one set of array elements representing or associated with a set of particular media elements; and
instructions to display the set of array elements in a screen area, to alter the array elements in the display according to a defined replacement pattern, and to allow a user to select an array element.

28. The physical medium of claim 27, wherein the altering is substantially continuous.

29. The physical medium of claim 27, wherein the array elements are cover art for CDs or DVDs.

30. The physical medium of claim 29, wherein the cover art is displayed in a small array having fewer elements than the media elements in the set.

31. The physical medium of claim 30, wherein the small array is a 2×2 or 3×3 square array.

32. The physical medium of claim 30, wherein the small array is rectangular or non-rectilinear array.

33. The physical medium of claim 30, wherein the replacement pattern comprises fading slowly in a clockwise or counter-clockwise pattern.

34. The physical medium of claim 27, wherein the instructions further comprise instructions to specify a database filter rule to select a set of array elements.

35. The physical medium of claim 34, wherein the set of array elements consists of items from a user's library.

36. The physical medium of claim 27, wherein the set of array elements includes external information in response to external metadata.

37. The physical medium of claim 27, wherein the set of array elements is weighted according to relative importance of the elements.

38. The physical medium of claim 27, wherein the instructions further comprise instructions to display elements in at least one of different frequency, different size, different durations, different focus, different resolution, different opacity, and different distances from center.

39. The physical medium of claim 27, wherein the instructions further comprise instructions to display elements responsive to similarity.

40. The physical medium of claim 27, wherein the instructions further comprise instructions to display elements responsive to type or rank.

41. The physical medium of claim 27, wherein set formation for the media elements is responsive to system settings.

42. The physical medium of claim 27, wherein set formation for the media elements is responsive to user preferences.

43. The physical medium of claim 27, wherein a collage structure is responsive to system settings.

44. The physical medium of claim 27, wherein a collage structure is responsive to user preferences.

45. The physical medium of claim 27, wherein the instructions further comprise instructions to present sound associated with the media elements responsive to metadata.

46. The physical medium of claim 27, wherein the instructions further comprise instructions to allow a user to purchase elements missing from the user's library.

47. Apparatus including
an input port disposed for receiving information representative of at least a portion of a set of array elements;
one or more output elements coupled to the input port, capable of displaying the set of array elements in a screen area representing a set of particular media elements;
wherein the array elements are displayed in a replacement pattern;
wherein the displaying is dynamic;
memory responsive to at least one of the output elements and disposed to maintain a status of at least one of the array elements; and
a selection mechanism configure for a user to select an array element.

48. The apparatus of claim 47, wherein the replacement pattern is substantially continuous.

49. The apparatus of claim 47, wherein the array elements are cover art for CDs or DVDs.

50. The apparatus of claim 49, wherein the cover art is displayed in a small array having fewer elements than the media elements in the set.

51. The apparatus of claim 50, wherein the small array is a 2×2 or 3×3 square array.

52. The apparatus of claim 50, wherein the small array is rectangular or non-rectilinear array.

53. The apparatus of claim 50, wherein the replacement pattern comprises fading slowly in a clockwise or counter-clockwise pattern.

54. The apparatus of claim 47, wherein the memory is further disposed to specify a database filter rule to select a set of array elements.

55. The apparatus of claim 47, wherein the set of array elements consists of items from a user's library.

56. The apparatus of claim 47, wherein the set of array elements includes external information in response to external metadata.

57. The apparatus of claim 47, wherein the set of array elements is weighted according to relative importance of the elements.

58. The apparatus of claim 47, wherein the memory is further disposed to display elements in at least one of different frequency, different size, different durations, different focus, different resolution, different opacity, and different distances from center.

59. The apparatus of claim 47, wherein the memory is further disposed to display elements responsive to similarity.

60. The apparatus of claim 47, wherein the memory is further disposed to display elements responsive to type or rank.

61. The apparatus of claim 47, wherein set formation for the media elements is responsive to system settings.

62. The apparatus of claim 47, wherein set formation for the media elements is responsive to user preferences.

63. The apparatus of claim 47, wherein a collage structure is responsive to system settings.

64. The apparatus of claim 47, wherein a collage structure is responsive to user preferences.

65. The apparatus of claim 47, wherein the memory is further disposed to present sound associated with the media elements responsive to metadata.

66. The apparatus of claim 47, wherein the memory is further disposed to allow a user to purchase elements missing from the user's library.

67. A method as in claim 1, wherein the steps of altering include steps of
cycling the array elements in the display.

68. A method as in claim 1, wherein there are fewer array elements than the media elements in the set.

69. A method as in claim 1, including steps of
selecting that at least one set of array elements substantially in response to media elements in that set of particular media elements.

70. A physical medium as in claim 27, wherein the instructions to alter include instructions to cycle the array elements in the display.

71. An apparatus as in claim 47, wherein the array elements are cycled in the replacement pattern.
